(19) United States
(12) Patent Application Publication
(10) Pub. No.: US 2009/0167529 A1
(43) Pub. Date: Jul. 2, 2009

(54) Electronic fence using wireless mesh network

(76) Inventor: Avi Kashi, Marlboro, NJ (US)

Correspondence Address: Avi Kashi, 3, Diamond Hill Rd, Marlboro, NJ, 07746, US

(21) Appl. No.: 11/964,957

(22) Filed: Dec. 27, 2007

(51) Int. Cl. G08B 13/00

(52) U.S. Cl. 340/541

(57) ABSTRACT

The current problem in protecting a secure area which can be a border between countries, Federal facility, Army deployment or even a house is that we are relying for the most part on a fence, cameras, electric fence, which takes a longer time to install. It is very expensive and cannot locate the point of entry. Sometime it is too late to react if someone cuts the fence and enters the secure area. My patent is to provide a very fast solution, early detection, identify the location of entry and all wireless systems which will allow implementing this idea in any location even in enemy fields where you wish to protect troops, army facilities and more.

The main idea is to spread a large amount of units (will refer to them as balls) over any area which needs to be secured, All balls will be equipped with mesh-network transceivers and sensing devices such as motion detectors for movement change and microphones for sound change. Once the unit gets triggered a signal will be sent from the transceiver to other units in the vicinity. In the end it will reach a main unit which will send all data to the monitoring center.

### BACKGROUND OF INVENTION

1. Field of Invention

The current invention was developed to create a different concept in which an area can be protected by creating a Mesh Network of Sensors. These Sensors will be totally independent, fully wireless with no distance limit. They can be implemented in a very fast method. The main benefit of this system is to provide the Monitoring Center with the location where the Sensor was triggered.

2. Description of Prior Art

A—Currently the method of protecting an area is by placing a fence around it.

B—Some of these fences are barbed wired.

C—Tall walls are also used to keep intruders out.

D—Electronic Fences which is a regular fence with different types of sensors integrated inside them.

All current devices are very expensive to implement and take a long time to build. In most cases they could be easily fooled. In some areas, where topographically it is impossible to place fences, these sensors will be more beneficial. The system is totally Independent by using a Mesh Networked Sensor in which:
A—The Signal may be routed by many paths. This means that if one of the sensors stops functioning, the signal will still go through via other Transceivers.
B—Self Healing—The System will be fully supervises, in which it will constantly look for all devices on the network and verify they are working properly.
C—Complete Wireless—All Units will run on batteries that will be recharged by the sun.
D—All units can be dropped by a plane, cars, and workers in order to provide speedy solutions.

### APPLICATIONS WHERE THIS INVENTION MAY BE USED

create a virtual border between countries in order to notify Illegal intruders.

create a “no walk zone” near high security areas such as Jails, Army Installations, and Federal Buildings.

Provide and instant fence for temporary deployment, buildings under construction, and Much more.

Provides a Buffer Zone for early notification for all Illegal entries.

Provides enemy movement notification and more.

### TECHNICAL EXPLANATION

The rechargeable battery can be either Nickel-Metal Hydride or lithium or any others based on application and specs from customer. And will be connected to a very small solar panel that will be placed on top of sensor and will convert sunlight to voltage and will recharge battery. This method will allow longer life for the device and as option the system can be configured to notify the user for low battery in which the battery is no longer effective. The main function for the battery is to provide a constant power to all devices in unit. You need to keep in mind that the units are very low in power consumption and always in a sleep mode. the only time they wave up is when alarm is accured or for a scheduled supervision test.

The transceiver is the brain and comes in a very small chip configuration and can be based on Zigbee or Zwave technology their functions are to process all data, transmit signals to the nearest device and supervise himself for voltage, link to other units in where if he doesn't see other units in the network he will have the option of increasing the transmission gain till he gets into network, in worse case is that the whole system won't see him and and won't count on him to relay any signal. These units are programmable to for self adjusting, gain, distance, limits, supervision, priorities and more and they are very inexpensive to implement. The rough distance between transmitters is about 30-75 ft and can be adjusted. Their power consumption is around 1 mw when active and almost 0 when sleep. The links between all transceiver is done automatically and will dynamically routes from any blocked node to a clear path

Motion sensors are the sensors placed on top of units and can be based on infrared technology, body heat, movement or any other type of motion sensing, the power to them is provided by the Rechargeable battery and they are always looking for any change of condition once that accured a signals gets set to the transceiver.

Microphone is to sense any different in sound conditions and can be adjusted in order to avoid false alarm. The sensor will be located on to of unit in order no to be blocked

Unit position once dropped by plans or trucks is to put a small weight on bottom and be configured in shape in which the units will always will be laying on their bottom part so the motion will be directed on top to view any movement, microphone will b on top in order not to be blocked, The solar mini panel to be directed to sun light and the antenna will be on top for maximum reception And the units will be enclosed in stone or small rock look alike in order to avoid detection by enemy, illegal immigrants, or anyone who is not allowed to be in that area

Gps reader is a single chip unit which will be powered by the battery and the function is simply to read The Gps locations and send them to the transceiver. Which will be used to report the monitoring service their location?

Transmitter can be different types based on customer requirements and locations in where this method is implemented, A direct RF transmission can be set for a fast, very independent but will require to create receiver units on control station and has a distance limits, the 2^{nd} method is cellular service in which the system can use existing cellular service to communicate, the 3^{rd} option is Satellite in which the main benefit is if wish to implement this patent in enemy ground

### EXPLANATION OF FIGURES

FIG. 1

This Figure Gives an Example of How this Patent Can Be Used.

Assuming dropping or installing a mix of Masters and Slaves across the boarder of the United States and Mexico. Once dropped, a Mesh Network is created and all Data is forwarded to the Monitoring Service. Once the Illegal Trespassers are crossing over the Sensors, a signal will be routed to the nearest Master in which an alarm, with its own ID and location will be sent to the Monitoring Service. Once the Monitoring Service receives an alarm, a blinking light will appear on a screen providing his location. The System may also be configured in any way in which two or more sensors needs to be triggered in order to avoid false alarms.

FIG. 2

Provides a Brief Explanation of what the Slave Unit Includes.

As mentioned earlier, the units will include a sensing device and transceiver with an antenna that will wait for a signal from his sensor. It may also be used as a router to receive signals from other slaves and forward them to the Master.

FIG. 3

Shows a Brief Description of what the Master Will Include:

As mentioned earlier, the Master includes all of the above plus a GPS Reader which allows the unit to know its exact location. It also has a transmitter that comes in different configurations depending on the applications.

FIG. 4

Shows a Side View of Product

The only items which are visible to outside is the enclosure, solar panel, motion sensor eye, microphone, The leg on bottom part is for pushing unit in ground

FIG. 5

Shows Top View Unit

On top the only visible units are the enclosure top, solar panel, and microphone

### NOTES

All electronic equipment such as the board with GPS reader, Transceivers, Battery, Antennas are placed inside the enclosure and seal from any weather condition.

The enclosures can come in different configurations and shapes based on the customer specification If for example the army is looking to create a covert line which will be notified on enemy movement so in this case the enclosure can be in a small rock or a stone look alike

Attachments:

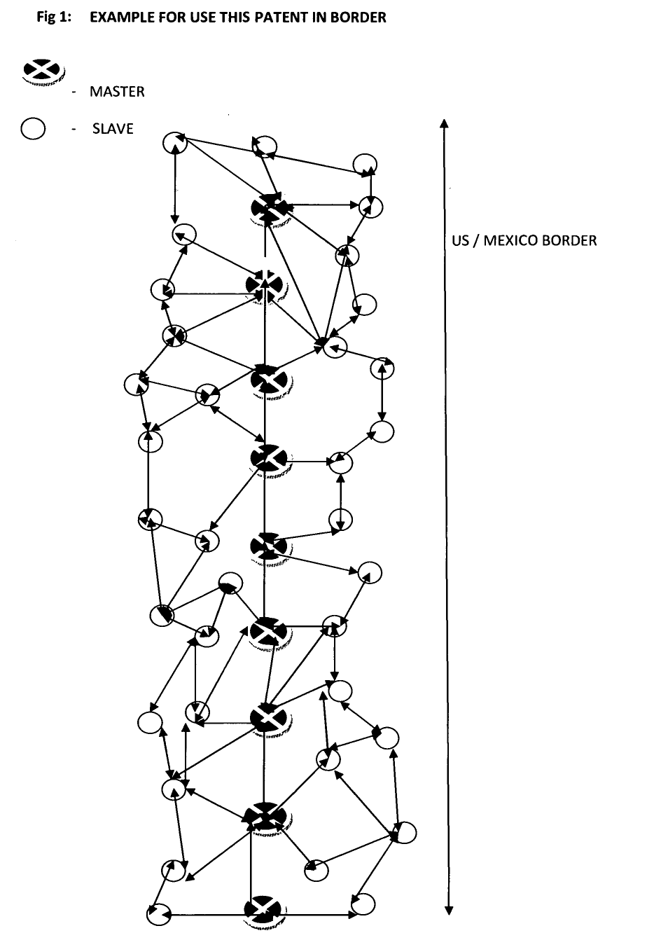

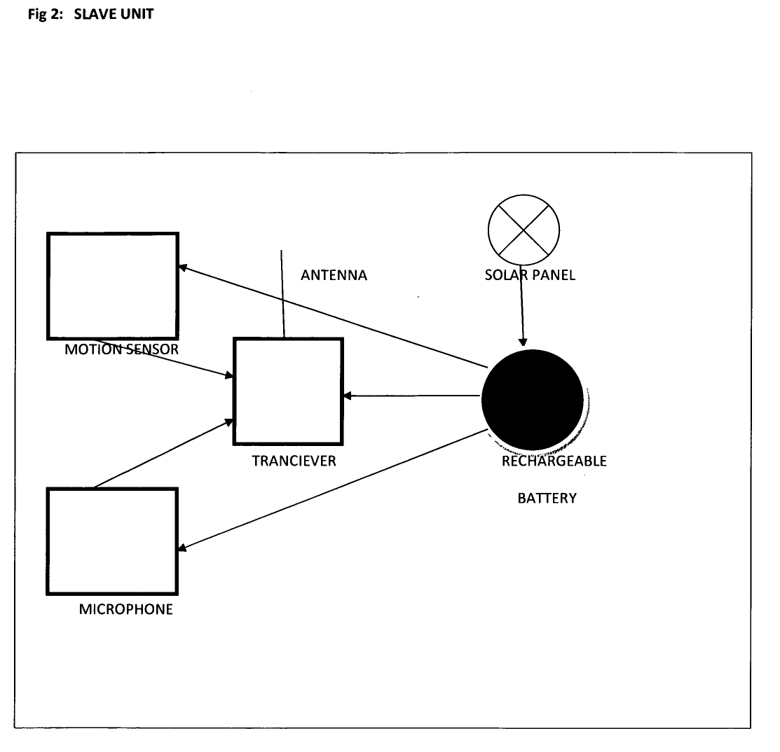

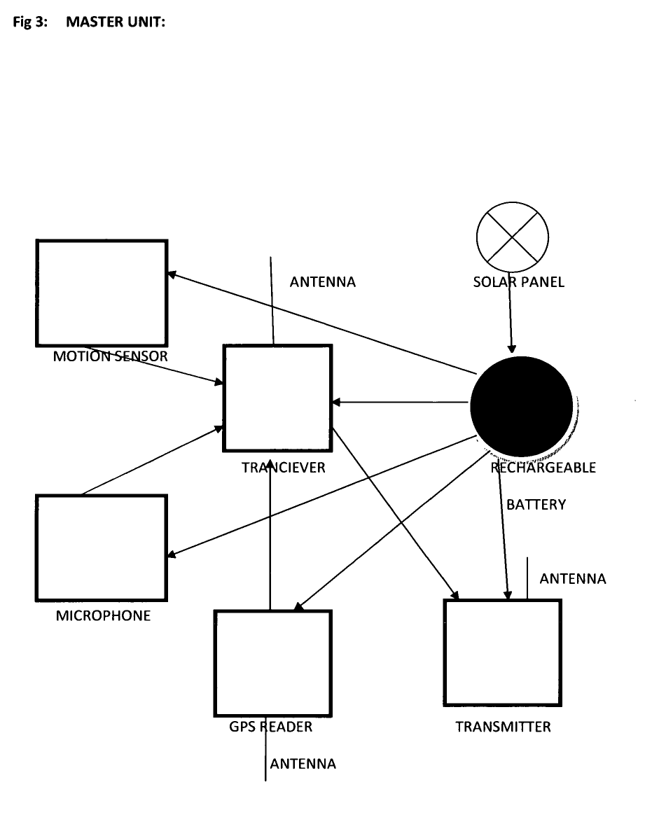

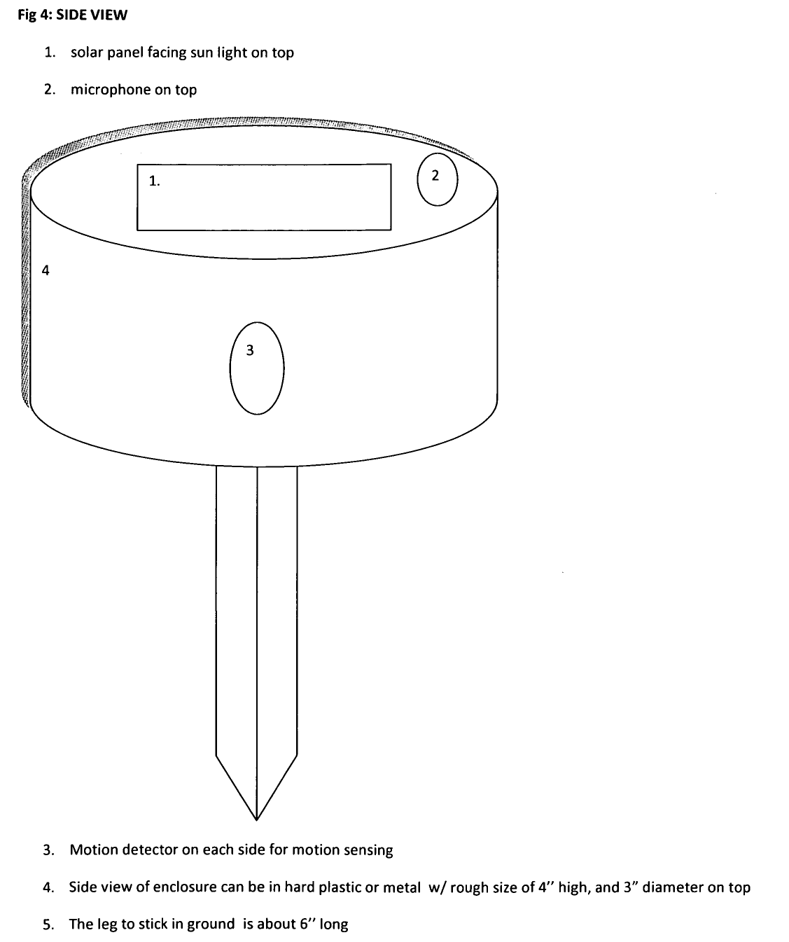

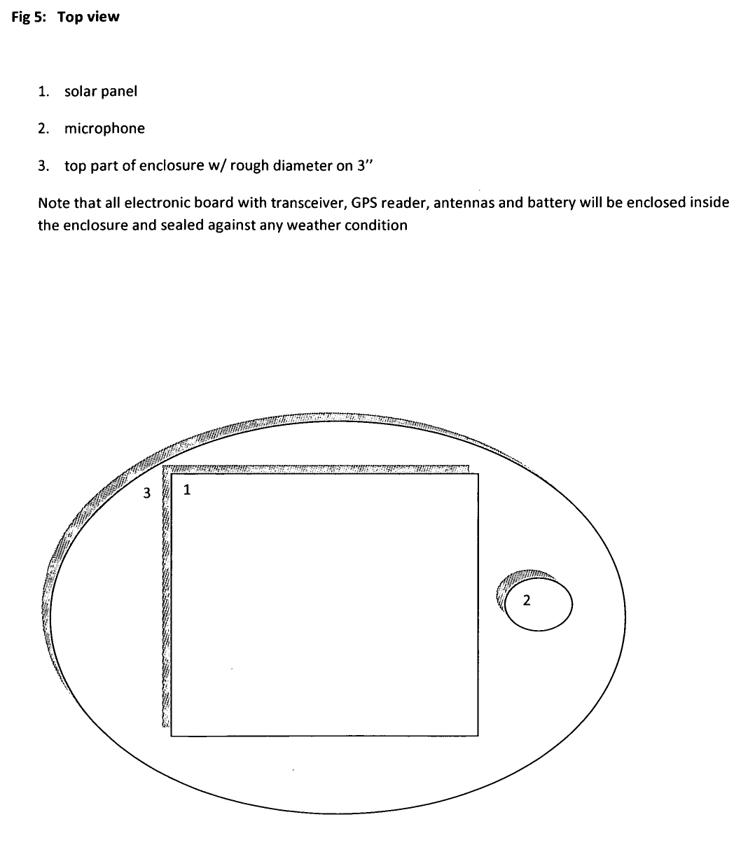

FIG. 1: EXAMPLE FOR USE THIS PATENT IN BORDER

FIG. 2: SLAVE UNIT

FIG. 3: MASTER UNIT

FIG. 4: SIDE VIEW

FIG. 5: TOP VIEW

What is claimed is:

1- An Electronic Fence will use Mesh Network Devices. The devices will be categorized as Masters and Slaves. The Slaves will include rechargeable batteries with a miniature solar panel. It will also include a Transceiver and a Sensing Device. The Masters will include the same as the Slave, but in addition will add a GPS Reader and a Transmitter. Once these units are delivered to the Protected Area, the Masters will read their GPS Locations and will search for the Slaves in their vicinity. Afterwards, all Data is being sent to the Monitoring Center where it is studied and a map of all units gets created

2- The rechargeable battery according to claim 1, is to send power to all devices inside the unit.

3- The Solar Panel according to claim 1, is to transfer sunlight and to recharge the battery.

4- The Transceiver according to claim 1 is the Brain of each device and collects signals and repeats them to the nearest transceivers.

5- The GPS Reader according to claim 1, is to allow the Master to know its exact location where it was dropped.

6- The Transmitter according to claim 1, is to transmit all data collected, which can be an Alarm, Supervision, Locations, and Network Strength. It will transmit all information to the nearest Monitoring Center via Satellite, Cellular, or Direct RF Connection.
